(19) United States
(12) Patent Application Publication
(10) Pub. No.: US 2019/0261448 A1
(43) Pub. Date: Aug. 22, 2019

(54) WIRELESS COMMUNICATION METHOD AND APPARATUS

(71) Applicant: Huawei Technologies Co., Ltd., Shenzhen (CN)

(72) Inventors: Xingxing HU, Shanghai (CN); Dong LIU, Shenzhen (CN); Tianle DENG, Shenzhen (CN)

(21) Appl. No.: 16/400,725

(22) Filed: May 1, 2019

Related U.S. Application Data
(63) Continuation of application No. PCT/CN2017/109388, filed on Nov. 3, 2017.

(30) Foreign Application Priority Data
Nov. 3, 2016 (CN) 201610959206.6

(51) Int. Cl. H04W 76/28; H04W 72/04; H04W 24/10; H04W 52/02; H04B 17/318

(52) U.S. Cl. CPC H04W 76/28; H04W 72/046; H04B 17/318; H04W 52/0245; H04W 24/10

(57) ABSTRACT

This application relates to the field of mobile communications, and in particular, to a discontinuous reception (DRX) technology in a wireless communications system. In a wireless communication method provided in this application, a terminal device (UE) receives, in a DRX cycle, a downlink control signal sent by a radio access network device; parses the downlink control signal; and if the downlink control signal fails to be parsed, measures wireless communication quality of a first beam pair, and determines, based on a measurement result, whether to continuously measure another beam pair, to determine a target beam. According to the solutions provided in this application, beam training and reporting of requested radio resources can be effectively reduced, and power consumption of the UE is reduced.

### CROSS-REFERENCE TO RELATED APPLICATIONS

This application is a continuation of International Application No. PCT/CN2017/109388, filed on Nov. 3, 2017, which claims priority to Chinese Patent Application No. 201610959206.6, filed on Nov. 3, 2016. The disclosures of the aforementioned applications are hereby incorporated by reference in their entireties.

### TECHNICAL FIELD

The present application relates to the field of mobile communications, and in particular, to a discontinuous reception (DRX) technology in a wireless communications system.

### BACKGROUND

Packet communication features burstiness. To be specific, after occasional sending of a packet, a communication silent state usually lasts for a relatively long time. Therefore, if a terminal device (also as user equipment (UE)) always listens to a downlink control channel of each subframe regardless of whether there is data, a receiver circuit of the UE is always in an enabled state. This causes relatively large power consumption.

To reduce this part of power consumption of the UE, a DRX technology is used in a Long Term Evolution (LTE) system. A base station configures a DRX cycle for the UE. In each DRX cycle, the UE is in an active period (On Duration) only in a specific subframe or several specific subframes, and listens to downlink control channels of these subframes, and the UE is in a sleep state in remaining subframes, to reduce power consumption of the UE.

Different from a low-frequency omnidirectional antenna communication manner used by an LTE base station, a directional beamforming communication manner is used for high-frequency communication due to a relatively great path loss of the high-frequency communication. Therefore, coverage of the high-frequency communication is different from a coverage area of an omnidirectional antenna. If a DRX mechanism of the LTE is still used directly, the UE may receive data from the base station at a moment before On Duration. However, due to possible displacement or receiving direction rotation in a sleep period of the UE, when the UE wakes up next time, a receive beam of the UE and a transmit beam of the base station do not match any more. This causes a communication failure.

### SUMMARY

This specification describes a DRX cycle management method, an apparatus, and a system, to implement better balance between system performance and power consumption of UE.

According to a first aspect, an embodiment of this application provides a wireless communication management method, where the method may be applied to a scenario in which a multi-beam communications technology is used, and the method includes: in a discontinuous reception (DRX) cycle, receiving, by a terminal device on a beam pair, a downlink control signal sent by a radio access network device; and when the UE fails to parse the downlink control signal, measuring, by the terminal device, wireless communication quality of the beam pair.

With reference to the first aspect, in a first possible implementation of the first aspect, the terminal device preferentially measures wireless communication quality of an original serving beam pair to determine whether the original serving beam pair meets a preset condition. When the original serving beam meets the preset condition, the terminal device determines the original serving beam pair as a serving beam for subsequent communication. The preset condition is used to determine, through measurement, whether a beam meets a use condition under an existing communication condition. For example, the preset condition may be that a parameter value such as beam signal strength or a beam signal signal-to-noise ratio obtained through measurement is higher than a preset threshold. The threshold may be determined based on parameters such as a decoding capability of the terminal device, whether multi-antenna or single-antenna receiving is used, and a current data service type.

With reference to the first aspect, in a second possible implementation of the first aspect, when the original serving beam does not meet a preset condition, the terminal device needs to measure another beam, and calculate a measurement value of the another beam pair to determine whether the preset condition is met. When finding a beam pair that meets a use condition, the terminal device may stop further measurement, and use, as a serving beam pair, the beam that meets the use condition.

With reference to the first possible implementation of the first aspect, in a third possible implementation of the first aspect, the terminal device enters a sleep state. Because it is determined that the original serving beam is still available, there is no need to report a to-be-used serving beam to a base station. Therefore, radio resources and power consumption required for reporting are reduced.

With reference to the second possible implementation of the first aspect, in a fourth possible implementation of the first aspect, because the original serving beam does not meet the use condition, the terminal device finds, through re-measurement (beam training), a beam that meets the use condition. In this case, the terminal device needs to report the beam pair.

According to a second aspect, an embodiment of this application provides a wireless communication management method, where the method may be applied to a scenario in which a multi-beam communications technology is used, and includes: before an active period in a DRX cycle, measuring, by a terminal device, wireless communication quality of a beam pair; and listening to, by the terminal device, a data indication signal, where the data indication signal is used to indicate whether there is data to be delivered to the terminal device.

With reference to the second aspect, in a first possible implementation of the second aspect, the terminal device preferentially measures wireless communication quality of an original serving beam pair to determine whether the original serving beam pair meets a preset condition. When the original serving beam meets the preset condition, the terminal device determines the original serving beam pair as a serving beam for subsequent communication. The preset condition is used to determine, through measurement, whether a beam meets a use condition under an existing communication condition. For example, the preset condition may be that a parameter value such as beam signal strength or a beam signal signal-to-noise ratio obtained through measurement is higher than a preset threshold. The threshold may be determined based on parameters such as a decoding capability of the terminal device, whether multi-antenna or single-antenna receiving is used, and a current data service type.

With reference to the second aspect, in a second possible implementation of the second aspect, when the original serving beam does not meet a preset condition, the terminal device needs to measure another beam, and calculate a measurement value of the another beam pair to determine whether the preset condition is met. When finding a beam pair that meets a use condition, the terminal device may stop further measurement, and use, as a serving beam pair, the beam that meets the use condition.

With reference to the first or second possible implementation of the second aspect, in a third possible implementation of the second aspect, when the terminal device fails to detect the data indication signal through listening or the data indication signal indicates that there is no data, the terminal device enters a sleep state.

With reference to the second possible implementation of the second aspect, in a fourth possible implementation of the second aspect, when the terminal device detects the data indication signal through listening or the data indication signal indicates that there is data, the terminal device reports the serving beam pair.

According to a third aspect, an embodiment of the present disclosure provides a terminal device, where the terminal device has a function of implementing behavior of the terminal device in the foregoing method designs. The function may be implemented by hardware, or implemented by hardware executing corresponding software. The hardware or software includes one or more modules that correspond to the foregoing functions. The modules may be software and/or hardware.

According to a fourth aspect, an embodiment of this application provides a terminal device, where the terminal device may be applied to a scenario in which a multi-beam communications technology is used, and the terminal device may perform the first aspect or the second aspect and any possible implementation of the first aspect or the second aspect.

According to a fifth aspect, an embodiment of this application provides a terminal device, where the terminal device may be applied to a scenario in which a multi-beam communications technology is used. The terminal device may include at least one processor, a memory, and a transceiver, where the transceiver is configured to exchange required information between the terminal device and another device, and the processor is configured to execute a program instruction in the memory, so that the terminal device can perform the first aspect or the second aspect and any possible implementation of the first aspect or the second aspect.

According to a sixth aspect, an embodiment of this application further provides a computer storage medium, where the storage medium stores a program instruction, and when the program instruction is directly or indirectly executed by one or more processors, the first aspect or the second aspect and any possible implementation of the first aspect or the second aspect can be implemented.

According to a seventh aspect, an embodiment of this application further provides a computer program product including an instruction, where when the computer program product is directly or indirectly run on a computer, the computer performs the first aspect or the second aspect and any possible implementation of the first aspect or the second aspect.

According to an eighth aspect, an embodiment of this application further provides a chip, where the chip may be applied to a terminal device. The chip may include at least one processor and a memory, where the at least one processor is configured to execute a program instruction in the memory, so that the chip can perform the first aspect or the second aspect and any possible implementation of the first aspect or the second aspect.

Compared with the prior art, in the solutions provided in the present disclosure, a DRX cycle may be more flexibly managed, to implement better balance between system performance and power consumption of UE.

### BRIEF DESCRIPTION OF DRAWINGS

FIG. 1 is a schematic diagram of a possible system network for implementing the present disclosure;

FIG. 2 is a schematic diagram of a possible application scenario according to the present disclosure;

FIG. 3 is a schematic diagram of one DRX cycle;

FIG. 4 is a schematic flowchart of a wireless communication method according to an embodiment of the present disclosure;

FIG. 5 is a schematic diagram of a frame structure in a wireless communication method according to an embodiment of the present disclosure;

FIG. 6 is a schematic diagram of a frame structure in a wireless communication method according to an embodiment of the present disclosure;

FIG. 7 is a schematic flowchart of a wireless communication method according to an embodiment of the present disclosure;

FIG. 8 is a schematic diagram of a frame structure in a wireless communication method according to an embodiment of the present disclosure;

FIG. 9 is a schematic diagram of a cycle structure in a wireless communication method according to an embodiment of the present disclosure; and

FIG. 10 is a schematic structural diagram of a terminal device according to an embodiment of the present disclosure.

### DESCRIPTION OF EMBODIMENTS

The technical solutions in the embodiments of the present disclosure are clearly described in the following with reference to the accompanying drawings. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

A network architecture and a service scenario are described in the embodiments of the present disclosure to describe the technical solutions in the embodiments of the present disclosure more clearly, and but not constitute a limitation on the technical solutions in the embodiments of the present disclosure. A person of ordinary skill in the art may learn that with evolution of network architectures and appearance of new service scenarios, the technical solutions in the embodiments of the present disclosure are also applicable to a similar technical problem.

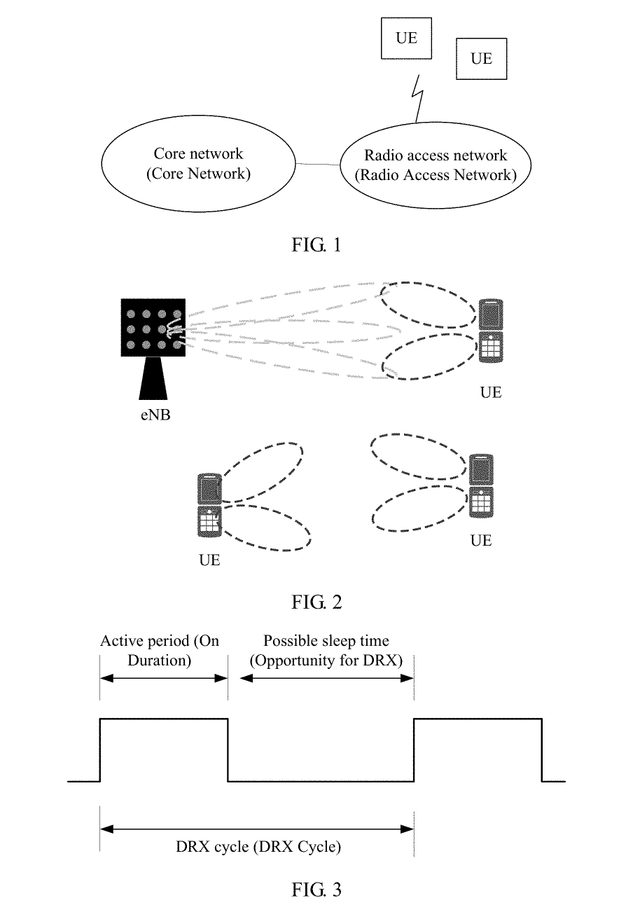

As shown in FIG. 1, user equipment (UE) accesses a radio access network (RAN). Technologies described in the present disclosure are applicable to a Long Term Evolution (LTE) system, or other wireless communications systems using various radio access technologies, for example, systems using access technologies such as Code Division Multiple Access, Frequency Division Multiple Access, Time Division Multiple Access, orthogonal frequency division multiple access, or single carrier frequency division multiple access. In addition, the technologies may be further applicable to a subsequent evolved system using an LTE system, for example, a 5th Generation (5G) system. For clarity, the LTE system is merely used as an example herein for description.

In this application, nouns “network” and “system” are often interchanged for use, but a person skilled in the art may understand meanings of the nouns. UE in this application may include a handheld device, an in-vehicle device, a wearable device, or a computing device that provides a wireless communication function; another processing device connected to a wireless modem; and user equipment (UE), a mobile station (MS), a terminal, a terminal device (or terminal equipment), and the like in various forms. For ease of description, in this application, the foregoing devices are collectively referred to as user equipment (UE). The radio access network device in the present disclosure is an apparatus that is configured to provide a wireless communication function for the UE and that is deployed in a radio access network. The radio access network device may include base stations in various forms, such as a macro base station, a micro base station, a relay station, and an access point. In systems that use different radio access technologies, a device that has a function of a base station may have different names. For example, in an LTE network, the device is referred to as an evolved NodeB (eNB or eNodeB); in a 3rd generation 3G network, the device is referred to as a NodeB; in a 5G system, the device is referred to as a gNB. For ease of description, in this application, all the foregoing apparatuses that provide a wireless communication function for the UE are referred to as a base station.

As mentioned in the background, due to a relatively large path loss in high-frequency communication, a directional beamforming communication manner is used. Because there are a plurality of directional beams, to implement normal communication, the beams need to be matched first. Assuming that a base station has M beams in a cell in which UE is located, and the UE has N beams (both M and N are positive integers greater than or equal to 1), when the UE and the base station perform pairing or beam training, a maximum of M*N times of measurement are needed. As shown in FIG. 2, UE has two beams, and a base station communicating with the UE has three beams. Therefore, the UE and the base station need to perform measurement a maximum of 2*3times, to ensure normal communication. If the UE and the base station each have more beams, a quantity of beam measurement times also multiplies. This causes great power consumption of the UE. In addition, the UE further needs to report matched beams, so that the base station allocates radio resources. However, the UE performs beam training and reporting in each DRX cycle, to correctly receive data delivered by the base station, but the base station does not always send data to the UE each time after the UE performs beam training and reporting. Therefore, beam training and reporting/feedback before On Duration in which no data is received lead to a waste of power consumption.

FIG. 3 is a schematic diagram of one DRX cycle. The following gives a detailed description with reference to FIG. 3. In time domain, a time is divided into a plurality of consecutive DRX cycles (DRX Cycle). The DRX cycle is a cycle used to describe repeated occurrence of On Duration in a DRX mode. One DRX cycle includes an “On Duration” and an “Opportunity for DRX”. In an On Duration time segment, the UE listens to a physical downlink control channel (PDCCH), to receive downlink data. Therefore, the “On Duration” time segment may also be referred to as an active period. “Opportunity for DRX” is a possible sleep time. In this time segment, the UE disables a receiver, and the UE does not listen to the PDCCH, and does not receive data of a downlink channel, to reduce power consumption. Therefore, the “Opportunity for DRX” time segment may also be referred to as a dormant period.

An embodiment of the present disclosure provides a wireless communication method. The method may be applied to a multi-beam communications technology scenario shown in FIG. 2.

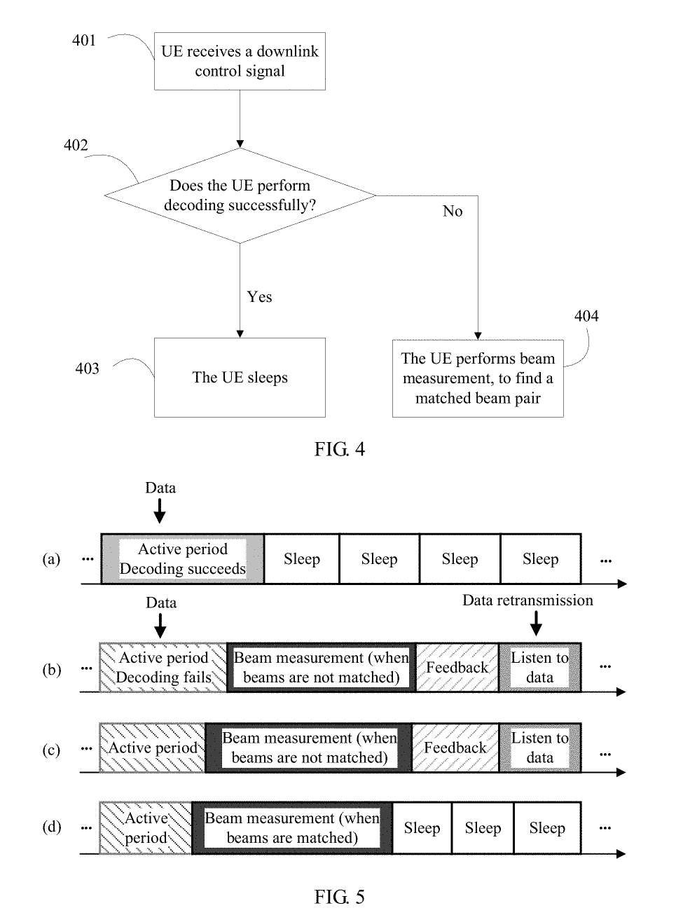

With reference to FIG. 4, the following describes, by using one DRX cycle as an example, a solution provided in an embodiment of the present disclosure.

S401: UE receives a downlink control signal sent by a base station.

S402: During On Duration, the UE first attempts to decode a downlink control channel, and selects a corresponding step based on a decoding result. For details, refer to four possible scenarios (a), (b), (c), and (d) in FIG. 5.

(1) When the base station has data to be sent to the UE, and the UE directly decodes the downlink control channel successfully when attempting to decode the downlink control channel in the On Duration, it indicates that the UE can normally communicate with the base station. The UE may directly sleep in other subframes in the DRX cycle, as shown in the scenario (a) in FIG. 5. In this case, decoding succeeds directly through an attempt, so that the UE can directly enter a dormant period, thereby greatly reducing overheads of the UE. In addition, the UE does not need to perform reporting/feedback to the base station, thereby saving air interface resources.

(2) When the base station has data to be sent to the UE, and the UE fails to decode the downlink control channel when attempting to decode the downlink control channel in the On Duration, or although the UE successfully decodes the downlink control channel in the On Duration, when attempting to decode a data channel indicated by the downlink control channel, the UE fails to decode the data channel, the UE needs to perform beam measurement, feed back a matched beam pair to the base station, and then monitor the downlink control channel to receive resent data, as shown in the scenario (b) in FIG. 5.

(3) When the base station has no data to be sent to the UE, and the UE fails to decode the downlink control channel when attempting to decode the downlink control channel in the On Duration, the UE performs beam measurement, feeds back a matched beam pair to the base station, and then continues to monitor and wait for a period of time (the UE does not know whether there is resent data), as shown in the scenario (c) in FIG. 5.

(4) When the base station has no data to be sent to the UE, and the UE fails to decode the downlink control channel when attempting to decode the downlink control channel in the On Duration, the UE always preferentially measures an original serving beam pair first. If the UE finds that the original serving beam still meets a use condition, the UE determines that there is no data currently, and directly sleeps, as shown in the scenario (d) in FIG. 5.

That the UE fails to decode the downlink control channel when decoding the downlink control channel may be caused for a plurality of reasons: For example, because the downlink control signal is too weak, the UE cannot correctly decode the downlink control channel. Alternatively, although the UE correctly receives the downlink control signal, because the downlink control signal is not intended for the UE, the UE cannot correctly decode the downlink control channel. That the UE fails to decode the downlink control channel may be understood as a parsing failure, or one or more parsing failures in a period of time.

Optionally, the control channel and the data channel may use different serving beam pairs. After correctly decoding the downlink control channel, the UE further needs to correctly decode the data channel, to complete data communication. Therefore, when the base station has no data to be delivered to the UE, as shown in the foregoing cases (3) and (4), the UE does not need to measure a serving beam of the data channel. When the base station has to-be-delivered data, as shown in the foregoing case (2), although the UE correctly decodes the control channel, when decoding of the data channel fails, the UE needs to measure a serving beam of the data channel, to find a beam pair that meets a condition. For a specific implementation, refer to a beam measurement process of the control channel. When it is found, through measurement, that a beam pair that meets the condition and that is of the data channel is different from the original serving beam pair, the UE needs to report the beam pair of the data channel, so that the base station delivers data information by using the beam pair.

According to a delay requirement of service data, the UE may immediately receive downlink data or wait for a next DRX cycle to receive downlink data.

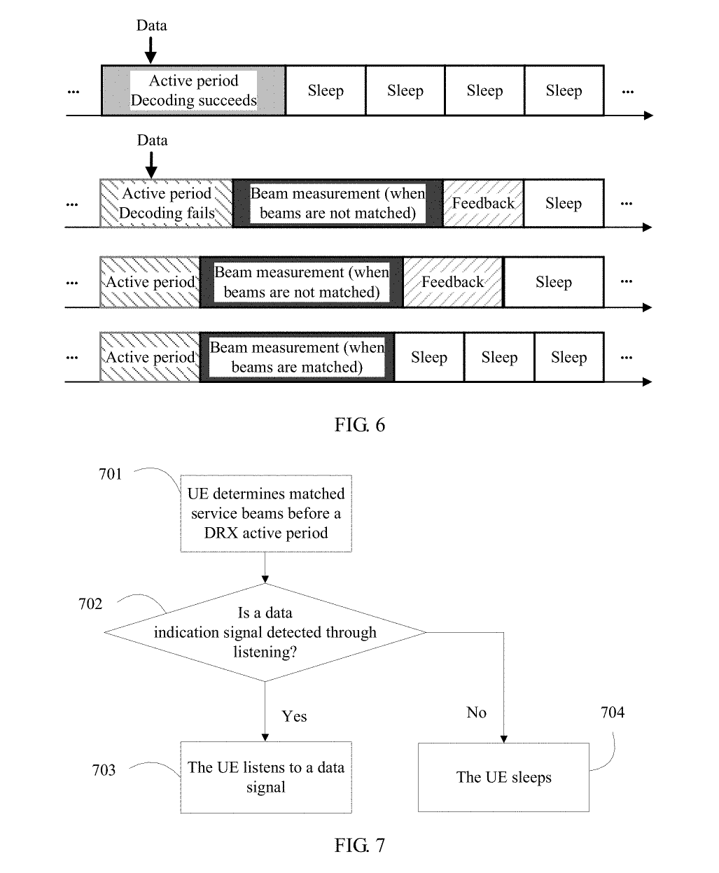

For a delay-insensitive scenario, the UE may choose to directly sleep after reporting matched beams, and wait for a next DRX cycle to receive data, as shown in FIG. 6.

In the foregoing scenarios (2), (3), and (4), the UE preferentially measures the original serving beam pair. When the original serving beam pair meets the use condition, the UE communicates with the base station by using the original serving beam. When the original serving beam pair is preferentially measured to determine whether the original serving beam pair meets the use condition, a beam pairing process and beam pairing overheads can be reduced. In addition, there is no need to perform reporting/feedback to the base station, thereby saving air interface resources. It should be noted that when the UE uses an omnidirectional antenna, the UE does not have a plurality of beams, or it may be understood that the UE has only one beam. In this case, the beam of the UE and one of a plurality of beams of the base station are construed as a beam pair. This specification is all described by using a concept of a beam pair.

Whether the original serving beam pair meets the use condition may be determined in the following manners:
The UE calculates a measurement value of the original serving beam pair, where the measurement value may be beam signal strength, a beam signal signal-to-noise ratio, or a combination thereof, for example, may be an average value, a weighted average value, or the like of the two parameter measurement values. It should be understood that only two measurement parameters are given herein, and parameters that can be used as measurement values include but are not limited to the two parameters.

When the measurement value is higher than a preset threshold, it may be considered that the original serving beam pair meets the use condition. The preset threshold may be determined in the following manner:
The base station determines the preset threshold. For example, the base station may determine the threshold based on parameters such as a decoding capability of the UE, whether multi-antenna or single-antenna receiving is used, and a current data service type. After determining the preset threshold, the base station may deliver the preset threshold to the UE through system message broadcasting or by using a MAC CE. The UE may also determine the preset threshold. For a specific determining manner, refer to the manner of determining the preset threshold by the base station.

When the measurement value is lower than the preset threshold, the UE needs to perform beam measurement, search for another matched beam pair, and report/feed back the matched beam pair to the base station, so that the base station records the beam pair, and subsequently delivers a data signal to the UE by using the beam pair. For a manner of determining whether the another beam pair meets the use condition, refer to the foregoing manner of determining whether the original serving beam pair meets the use condition. Details are not described herein again.

When finding a beam pair that meets the use condition, the UE may stop performing further measurement on other remaining beam pairs, and report the found beam pair to the base station. Optionally, the UE may alternatively perform further measurement to find a beam pair that has a best condition. Measurement is stopped when the beam pair that meets the use condition is found, to reduce power consumption and overheads of the UE.

An embodiment of the present disclosure further provides a wireless communication method. The method may be applied to a scenario in which a multi-beam communications technology is used. The following gives a detailed description with reference to FIG. 7.

5701: Before an active period in a DRX cycle, UE first performs beam measurement, to determine matched serving beams.

The UE preferentially measures an original serving beam, to determine whether the original serving beam meets a use condition. If the original serving beam does not meet the use condition, the UE determines, through measurement until a serving beam that can meet the use condition is found, whether another beam pair meets the use condition. For a specific implementation, refer to the detailed description in the previous embodiment.

5702: The UE listens to a data indication signal (data indicator), where the data indication signal is used to indicate whether there is data to be delivered to the UE, and the data indication signal may be represented by 1-bit data. For example, delivery of data 1 indicates that there is data to be delivered to the UE subsequently; and delivery of data 0 indicates that there is no data to be delivered to the UE subsequently. Alternatively, that the data indication signal is received indicates that there is data to be delivered to the UE, and that the data indication signal is not received indicates that there is no data to be delivered to the UE. Specific implementations include but are not limited thereto. The UE performs the following steps based on whether a data indication signal is detected through listening.

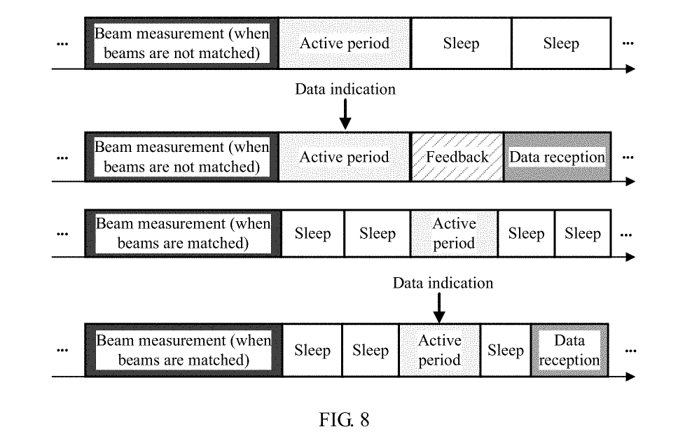

For details, refer to four possible scenarios (a), (b), (c), and (d) in FIG. 8.

(1) When a base station has no data to be sent to the UE, the UE performs beam measurement before the active period, to determine an available beam pair. As shown in the scenario (a) in FIG. 8, the UE finds, through measurement, that the original serving beam does not meet the use condition, and measures another beam pair to find an available serving beam. If the UE has not received the data indication signal, or the data indication signal indicates that there is no data to be delivered, the UE may directly sleep in other subframes in the DRX cycle. In this case, although the UE originally needs to continuously perform listening in the active period to determine whether there is data to be delivered, because the data indication signal is used to prompt the UE that there is no data to be delivered subsequently, the UE may directly enter a sleep state, and stay in the sleep state until a next DRX cycle, thereby greatly reducing overheads of the UE. If the UE performs beam measurement (beam training) before the active period, and finds that the original serving beam pair meets the use condition, the UE still does not need to perform reporting/feedback to the base station, thereby saving air interface resources and reducing power consumption.

(2) When the base station has data to be sent to the UE, the UE performs beam measurement before the active period, finds, through measurement, that the original serving beam does not meet the use condition, and measures another beam pair to find an available serving beam. After being prompted by using the data indication signal, the UE learns that there is data to be delivered subsequently, and the UE continuously listens to a channel. Before data delivery, the UE reports information about the determined available serving beam pair to the base station, as shown in the scenario (b) in FIG. 8.

(3) When the base station has no data to be sent to the UE, the UE performs beam measurement before the active period, and finds, through measurement, that the original serving beam meets the use condition, and after being prompted by using the data indication signal, the UE learns that there is no data to be delivered subsequently, as shown in the scenario (c) in FIG. 5, the UE may directly enter a sleep state. In this case, although the UE originally needs to continuously perform listening in the active period to determine whether there is data to be delivered, because the data indication signal is used to prompt the UE that there is no data to be delivered subsequently, the UE may directly enter a sleep state, and stay in the sleep state until a next DRX cycle, thereby greatly reducing overheads of the UE. Because the original serving beam is available, the UE still does not need to report an available serving beam pair to the base station.

(4) When the base station has data to be sent to the UE, the UE performs beam measurement before the active period, and finds, through measurement, that the original serving beam meets the use condition, and after being prompted by using the data indication signal, the UE learns that there is data to be delivered subsequently, as shown in a scenario (d) in FIG. 5. Because the original serving beam is available, the UE still does not need to report an available serving beam pair to the base station.

That the UE performs beam measurement before the active period may be understood as follows: The UE performs beam measurement before an active period in a DRX (to be specific, performs beam measurement in a dormant period), or the UE performs measurement in a period of time before an active period (On Duration) in a DRX cycle.

Optionally, a control channel and a data channel may use different serving beam pairs. After correctly decoding the downlink control channel, the UE further needs to correctly decode the data channel, to complete data communication. For a specific implementation, refer to description in the foregoing embodiment.

In this embodiment of the present disclosure, by using the data indication signal, the UE may know whether there is data to be delivered subsequently, to reduce listening overheads of the UE and radio resources consumption required for reporting.

The embodiments of the present disclosure further provide an embodiment, to redesign a beam measurement cycle based on the foregoing two embodiments.

Beam measurement and reporting may cause considerable power consumption. However, because movement and direction change of UE make a receive beam and a transmit beam unmatched, and the process of beam measurement and reporting is inevitable, a measurement frequency and a reporting frequency should be as low as possible in an acceptable range of a UE service.

An On Duration design in DRX cycle is based on burstiness of packet exchange, and is related to a packet receiving frequency. However, in an ideal case, beam measurement should be triggered when a receive beam and a transmit beam are unmatched, which is related to a movement speed and an orientation change speed of the UE. Therefore, a beam measurement cycle T_{b} does not need to be the same as a DRX cycle T_{d}. On the contrary, a case in which T_{b} is greater than T_{d} is more beneficial to energy saving of the UE.

Therefore, a relationship between T_{b} and T_{d} is configured as follows:

T_{b}=N×T_{d}, where

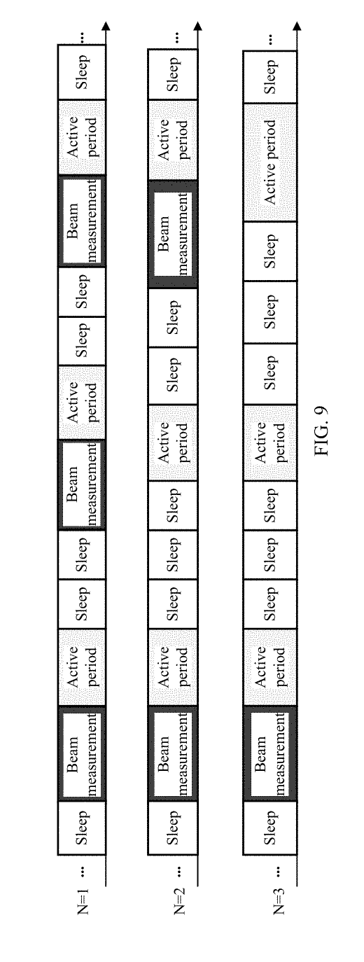

N≥1, N may be configured by the base station based on a service class of the UE and an environment in which the UE is located, and N may be dynamically configured by the base station depending on different scenarios in which the UE is located. FIG. 9 shows a schematic diagram in which N=1, 2, 3.

Beam measurement always starts from an original service receive-transmit beam pair. If original service receive-transmit beams meet a use condition, the UE sleeps directly without reporting, and waits for an active period. Alternatively, if the original service receive-transmit beams do not meet a use condition, the UE needs to report new matched receive-transmit beams, and then listens to a downlink control channel in an active period.

The beam measurement cycle is redesigned to be different from the DRX cycle, so that the beam measurement cycle is greater than the DRX cycle. This is because not all DRX cycles include a process of measurement and reporting. Therefore, radio resource occupation and power consumption caused by beam measurement and reporting can be reduced.

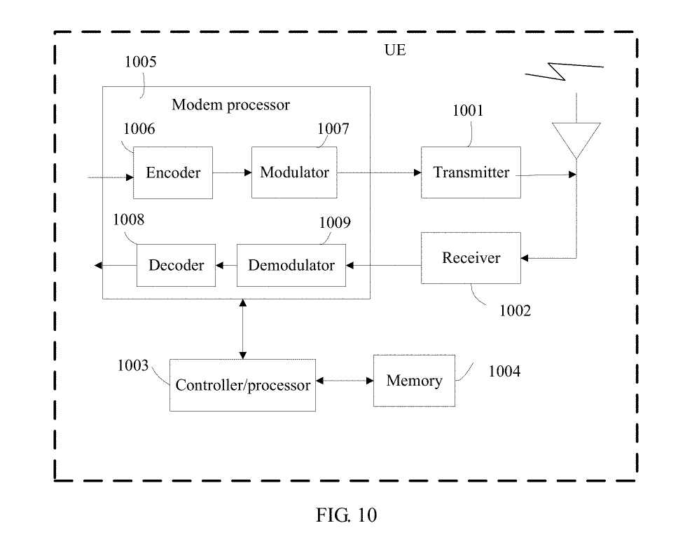

FIG. 10 is a simplified schematic diagram of a possible design structure of UE in the foregoing embodiments. The UE includes a transmitter 1001, a receiver 1002, a controller/processor 1003, a memory 1004, and a modem processor 1005.

The transmitter 1001 adjusts (for example, performs analog conversion, filtering, amplification, or up-conversion on) the output sampling and generates an uplink signal. The uplink signal is transmitted to the base station in the foregoing embodiments by using an antenna. On a downlink, the antenna receives a downlink signal transmitted by the base station in the foregoing embodiments. The receiver 1002 adjusts (for example, performs filtering, amplification, down-conversion, or digitalization on) a signal received from the antenna, and provides input sampling. In the modem processor 1005, an encoder 1006 receives service data and a signaling message that are to be sent on an uplink, and processes (for example, performs formatting, encoding, or interleaving on) the service data and the signaling message. A modulator 1007 further processes (for example, performs symbol mapping or modulation on) encoded service data and an encoded signaling message, and provides output sampling. A demodulator 1009 processes (for example, demodulates) the input sampling and provides a symbol estimation. A decoder 1008 processes (for example, performs de-interleaving and decoding on) the symbol estimation, and provides encoded data and an encoded signaling message that are sent to the UE. The encoder 1006, the modulator 1007, the demodulator 1009, and the decoder 1008 may be implemented by the composite modem processor 1005. These units perform processing according to radio access technologies (for example, access technologies of an LTE system and another evolved system) used by a radio access network.

The controller/processor 1003 controls and manages an action of the UE, and is configured to perform the processing performed by the UE in the foregoing embodiments. For example, the controller/processor 1003 is configured to control the UE to receive paging based on a received DRX long cycle and/or is configured to perform another process of a technology described in the present disclosure.

Method or algorithm steps described in combination with the content disclosed in the present disclosure may be implemented by hardware, or may be implemented by a processor executing a software instruction. The software instruction may be sent by a corresponding software module. The software module may be stored in a RAM, a flash memory, a ROM, an EPROM, an EEPROM, a register, a hard disk, a removable hard disk, a CD-ROM, or a storage medium of any other form known in the art. For example, a storage medium is coupled to a processor, so that the processor can read information from the storage medium, and can write information into the storage medium. Certainly, the storage medium may alternatively be a component of the processor. The processor and the storage medium may be located in an ASIC. In addition, the ASIC may be located in user equipment. Certainly, the processor and the storage medium may alternatively exist in the user equipment as discrete components.

A person skilled in the art should be aware that in the foregoing one or more examples, functions described in the present disclosure may be implemented by hardware, software, firmware, or any combination thereof. When the present disclosure is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a general-purpose or special-purpose computer.

The objectives, technical solutions, and beneficial effects of the present disclosure are further described in detail in the foregoing specific embodiments. It should be understood that the foregoing descriptions are merely specific implementations of the present disclosure, but are not intended to limit the protection scope of the present disclosure. Any modification, equivalent replacement, or improvement made based on the technical solutions of the present disclosure shall fall within the protection scope of the present disclosure.

What is claimed is:

1. A wireless communication method, comprising:
in a discontinuous reception (DRX) cycle, receiving, by a terminal device on a first beam pair, a downlink control signal sent by a radio access network device; and
when the terminal device fails to parse the downlink control signal, measuring, by the terminal device, wireless communication quality of the first beam pair.

2. The wireless communication method according to claim 1, wherein when the wireless communication quality of the first beam pair meets a preset condition, determining, by the terminal device, the first beam pair as a serving beam.

3. The wireless communication method according to claim 1, wherein when the wireless communication quality of the first beam pair does not meet a preset condition, measuring, by the terminal device, wireless communication quality of a second beam pair.

4. The wireless communication method according to claim 2, wherein the wireless communication quality of the first beam pair meets the preset condition when a measurement value, calculated by the terminal device, of the first beam pair is higher than a preset threshold.

5. The method according to claim 4, wherein after determining the first beam pair as the serving beam, the method further comprises:
entering, by the terminal device, a sleep state.

6. The wireless communication method according to claim 3, wherein the wireless communication quality of the first beam pair does not meet the preset condition when a measurement value, calculated by the terminal device, of the first beam pair is lower than a preset threshold.

7. The wireless communication method according to claim 3, wherein when the wireless communication quality, measured by the terminal device, of the second beam pair meets the preset condition, determining, by the terminal device, the second beam pair as a serving beam.

8. The wireless communication method according to claim 4, wherein the measurement value comprises at least one of the following parameters:
a beam signal strength and a beam signal signal-to-noise ratio.

9. The wireless communication method according to claim 4, further comprising:
receiving, by the terminal device, the preset threshold from a base station.

10. The wireless communication method according to claim 3, further comprising:
reporting, by the terminal device, the second beam pair.

11. The wireless communication method according to claim 3, wherein when the terminal device detects a data indication signal through listening or the data indication signal indicates that there is data, reporting, by the terminal device, the second beam pair.

12. A terminal device, comprising:
a receiver, configured to: in a discontinuous reception (DRX) cycle, receive, on a first beam pair, a downlink control signal sent by a radio access network device; and
a processor, configured to: when failing to parse the downlink control signal, measure wireless communication quality of the first beam pair.

13. The terminal device according to claim 12, wherein when the wireless communication quality of the first beam pair meets a preset condition, the processor is configured to:
determine the first beam pair as a serving beam.

14. The terminal device according to claim 12, wherein when the wireless communication quality of the first beam pair does not meet a preset condition, the processor is configured to:
measure wireless communication quality of a second beam pair.

15. The terminal device according to claim 13, wherein the wireless communication quality of the first beam pair meets the preset condition when a measurement value, calculated by the processor, of the first beam pair is higher than a preset threshold.

16. The terminal device according to claim 15, wherein the processor is configured to:
after determining the first beam pair as the serving beam, cause the terminal device to enter a sleep state.

17. The terminal device according to claim 14, wherein the measured wireless communication quality of the first beam pair does not meet the preset condition when a measurement value, calculated by the processor, of the first beam pair is lower than a preset threshold.

18. The terminal device according to claim 14, wherein when the measured wireless communication quality of the second beam pair meets the preset condition, the processor is configured to:
determine the second beam pair as a serving beam.

19. The terminal device according to claim 15, wherein the measurement value comprises at least one of the following parameters:
a beam signal strength and a beam signal signal-to-noise ratio.

20. A computer program product stored in a non-transitory medium, comprising instructions which, when executed by a computer, cause the computer to:
receive a downlink control signal sent by a radio access network device on a first beam pair in a discontinuous reception (DRX) cycle; and
when failing to parse the downlink control signal, measure wireless communication quality of the first beam pair.
